(19) United States
(12) Patent Application Publication
(10) Pub. No.: US 2011/0216418 A1
(43) Pub. Date: Sep. 8, 2011

(54) ERECT EQUAL-MAGNIFICATION LENS ARRAY

(75) Inventor: Takashi SHIRAISHI, Kanagawa-ken (JP)

(73) Assignees: Kabushiki Kaisha Toshiba, Tokyo (JP); Toshiba Tec Kabushiki Kaisha, Tokyo (JP)

(21) Appl. No.: 12/877,797

(22) Filed: Sep. 8, 2010

Related U.S. Application Data
(60) Provisional application No. 61/310,636, filed on Mar. 4, 2010.

(51) Int. Cl. G02B 27/12

(52) U.S. Cl. 359/619

(57) ABSTRACT

There is provided an erect equal-magnification lens array including: a plurality of first lenses causing light incident from an object point to each incidence plane, which has at least a partially planar shape, to be collected by each outgoing plane which has a convex shape; a plurality of second lenses aligned so as to correspond to each of the plurality of first lenses, having incidence planes each of which has a convex shape and is arranged in the vicinity of a position in the optical axis direction, at which the light is collected by each of the outgoing planes of the plurality of first lenses, and causing the light incident to each of the incidence planes to be collected again on an image plane using outgoing planes thereof each of which has a convex shape; and an aperture configured to shield light, from among the light collected by each of the outgoing planes of the plurality of first lenses, proceeding in a direction to be incident from each of the outgoing planes to the incidence planes of the second lenses other than the second lenses on the same optical axis.

### CROSS-REFERENCE TO RELATED APPLICATION(S)

This application is based upon and claims the benefit of priority from: U.S. provisional application 61/310,636, filed on Mar. 4, 2010; the entire contents all of which are incorporated herein by reference.

### FIELD

Embodiments described herein relate generally to an erect equal-magnification lens array.

### BACKGROUND

An erect equal-magnification lens array having two lens arrays is known in the related art.

These lens arrays each have a plurality of lens groups which are aligned in a direction perpendicular to an optical axis.

The above-mentioned erect equal-magnification lens array in the related art is generally constituted by combination of two lens arrays with the same shape.

However, in the case of the erect equal-magnification lens array in the related art which is constituted by two lens arrays and does not have an intermediate lens array which is provided in an erect equal-magnification lens array using three lens arrays, there is a problem that a significant portion of the light incident to each lens in the lens array of a former stage cannot be incident to the incidence plane of each lens in the lens array of a latter stage, and that the amount of light which forms an image on an image plane in practice is small.

On the other hand, there is a known countermeasure technique for solving the problem where the light amount is insufficient in the configuration in which two lens arrays are used.

However, according to the above-mentioned countermeasure technique, a deep groove is formed in the periphery of each lens constituting the lens array, and the light is guided to the lens plane by the groove. Accordingly, there is large variation in the thickness of the lens array at the time of formation, and it is difficult to enhance the precision of the lens plane shape and the overall shape. In addition, when a processing method of warming a plate material and pressing a mold onto the material is employed in the same manner as hot pressing, there is a large amount of deforming in the surface shape, which also results in a problem that highly precise processing is difficult.

### BRIEF DESCRIPTION OF THE DRAWINGS

FIG. 1 is a longitudinal sectional view illustrating a configuration of a scanning optical system of a scanner which is provided with an erect equal-magnification lens array according to an embodiment.

FIG. 2 is a perspective view of a breakdown illustrating a schematic configuration of the entire erect equal-magnification lens array according to the embodiment.

FIG. 3 is a longitudinal sectional view illustrating a configuration of only one pair of optical device group which is aligned along an optical axis of a lens in the erect equal-magnification lens array according to the embodiment.

FIG. 4 is a diagram illustrating a relationship between the function of each lens in an erect equal-magnification lens array which uses a combination of three lenses (left diagram) and the configuration of the erect equal-magnification lens array according to the embodiment (right diagram).

FIG. 5 is a plan view of an alignment of a plurality of first lenses in a first lens array when seen from above.

FIG. 6 is a diagram illustrating a hexagonal close-packed arrangement of the first lenses and the second lenses.

FIG. 7 is a diagram illustrating a state in which the light passes when the first lenses, the second lenses, and holes in first and second apertures are aligned in a direction shown in FIG. 5.

FIG. 8 is a diagram illustrating a state in which the light passes when the first lenses, the second lenses, and the holes in the first and second apertures are aligned in a direction perpendicular to the positional relation in FIG. 5.

FIG. 9 is a diagram illustrating a state in which occurrence of the stray light is suppressed while the sectional direction shown in FIG. 8 is assumed to be a direction in which the number of lens alignment columns is smaller.

FIG. 10 is a sectional view in a sub-scanning direction which shows the first and second apertures of the erect equal-magnification lens array according to the embodiment.

FIG. 11 shows lens data of the erect equal-magnification lens array according to the embodiment.

FIG. 12 shows aspherical coefficients of lens plane in the erect equal-magnification lens array according to the embodiment.

FIG. 13 is a diagram illustrating an aspherical formula.

FIG. 14 is a diagram illustrating a shape of a spherical portion of an outgoing plane of the first lens.

FIG. 15 is a diagram illustrating a shape of a spherical portion of an incidence plane of the second lens.

FIG. 16 is a diagram illustrating a shape of a spherical portion of an outgoing plane of the second lens.

FIG. 17 is a diagram for explaining conditions for increasing a light amount without allowing scattering light from the periphery of the first lenses to reach the second lenses.

FIG. 18 is a sectional view of the erect equal-magnification lens array in a main-scanning direction in which pitches between lenses are maximized.

FIG. 19 is a diagram illustrating an illuminance distribution in the incidence plane of the second lens in the state in FIG. 18 when the board thickness of the second aperture is set to be 0.85 mm.

FIG. 20 is a sectional view in the sub-scanning direction in which the pitches between lenses are minimized.

FIG. 21 is a diagram illustrating an illuminance distribution in the incidence plane of the second lens in the state in FIG. 20 when the board thickness of the second aperture is set to be 0.85 mm.

FIG. 22 is a diagram illustrating a state in which stray light occurs in all directions, which are perpendicular to the optical axis, after the light passed through the second aperture on the incidence plane of the second lens.

FIG. 23 is a diagram illustrating a state in which the stray light occurs in the sub-scanning direction on the incidence plane of the second lens but the stray light does not occur in the main-scanning direction, after the light passed through the second aperture.

FIG. 24 is a diagram illustrating a defocusing characteristic of MTF at 6 cycle/mm in the state shown in FIG. 11.

FIG. 25 is a diagram illustrating the defocusing characteristic of the MTF.

FIG. 26 is a diagram illustrating the defocusing characteristic of the MTF when pitches between holes of the second aperture in the sub-scanning direction are larger than pitches between lenses in the sub-scanning direction.

FIG. 27 is a table showing right-side values and left-side values in paraxial relation formula.

FIG. 28 is a diagram showing distortions of one set of lens group constituted by the first and second lenses which have the lens data shown in FIGS. 11 and 12.

FIG. 29 is a diagram showing distortions of one set of lens group which is optimized in the state where the lens planes are made to be spherical planes.

FIG. 30 is a diagram illustrating a state of an optical path when the lens planes of the first and second lenses are optimized only at their spherical planes.

FIG. 31 is a diagram illustrating a configuration in which the lenses have the same lens data as that shown in FIG. 11 and the first and second apertures are implemented as a single aperture.

FIG. 32 is a diagram illustrating a schematic configuration in which the erect equal-magnification lens array is employed as a writing optical system in an image forming apparatus.

### DETAILED DESCRIPTION

According to an embodiment, an erect equal-magnification lens array generally includes a plurality of first lenses, a plurality of second lenses and an aperture.

The plurality of first lenses are aligned in a direction perpendicular to optical axis and causes light incident from an object point to each incidence plane, which has a planar shape or an at least a partially planar shape, to be collected by each outgoing plane which has a convex shape.

The plurality of second lenses are aligned on a downstream side in a light beam proceeding direction on the optical axis of each of the plurality of first lenses, in a direction perpendicular to the optical axis so as to correspond to each of the plurality of first lenses. The plurality of second lenses are provided with incidence planes which have a convex shape and are arranged in the vicinity of a position in the optical axis direction where the light is collected by each of the outgoing planes of the plurality of first lenses, and causes the light incident to the incidence planes to be collected again on an image plane using outgoing planes which have a convex shape.

The aperture shields light, from among the light collected by each of the outgoing planes of the plurality of first lenses, proceeding in a direction to be incident from each of the outgoing planes to the incidence planes of the second lenses other than the second lenses on the same optical axis.

Hereinafter, a description will be made of the embodiment with reference to the accompanying drawings.

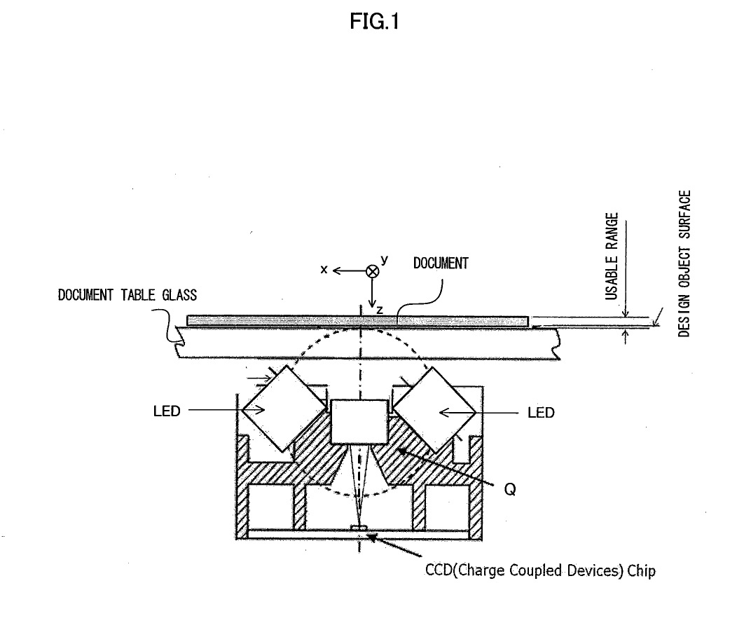

FIG. 1 is a longitudinal sectional view illustrating a configuration of a scanning optical system of a scanner which is provided with an erect equal-magnification lens array Q according to this embodiment. The erect equal-magnification lens array Q according to this embodiment is being employed for the scanning optical system in the scanner.

The erect equal-magnification lens array Q guides the light emitting from an LED and reflected by an original document plane to a CCD chip (light receiving device).

It is needless to say that another configuration is also suitable in which the erect equal-magnification lens array Q guides an illuminance light from a light source to a reading target plane of an original document in a reading optical system of a scanner for reading an image on the original document.

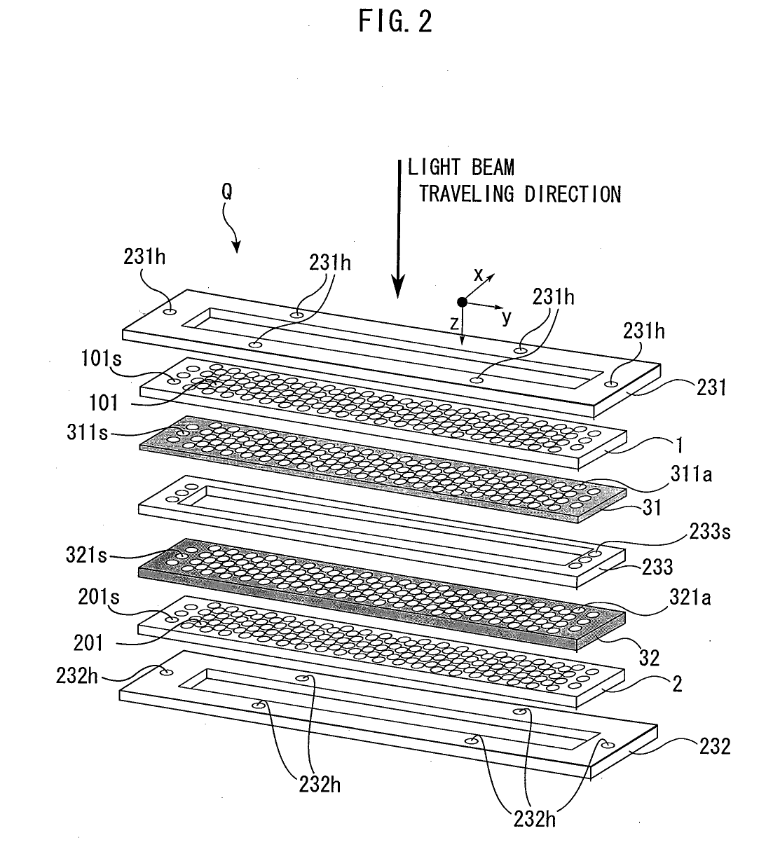

FIG. 2 is a perspective view of a breakdown illustrating a schematic configuration of the entire erect equal-magnification lens array Q according to this embodiment.

As shown in FIG. 2, the erect equal-magnification lens array Q of this embodiment is provided with a pressing plate 231, a first lens array 1, a first aperture 31, a spacer 233, a second aperture 32, a second lens array 2, and a pressing plate 232.

The above-mentioned respective constituents constituting the erect equal-magnification lens array Q according to this embodiment are arranged in the order of the pressing plate 231, the first lens array 1, the first aperture 31, a spacer 233, the second aperture 32, the second lens array 2, and the pressing plate 232 in a light beam proceeding direction.

The first lens array 1, the first aperture 31, a spacer 233, the second aperture 32, and the second lens array 2 are mutually fixed so as to be pinched between the pressing plate 231 and the pressing plate 232 by bolts, screws or the like inserted into a plurality of holes 231h and a plurality of holes 232h for positioning, in which female screws are formed.

In addition, protrusions (for example, convex lens shapes) 101s, 233s and 201s are formed on the planes of the first lens array 1, a spacer 233 and the second lens array 2, which face each of the apertures, at positions corresponding to holes 311s and 321s for positioning, which are formed in the first aperture 31 and the second aperture 32 on planes facing the respective lens arrays.

It is possible to perform positioning for the relative positional relationship of the first lens array 1, the first aperture 31, a spacer 233, the second aperture 32, and the second lens array 2 in a direction perpendicular to an optical axis by pinching the first lens array 1, the first aperture 31, a spacer 233, the second aperture 32, and the second lens array 2 using the pressing plates 231 and 232 in the state where the protrusions 101s, 233s and 201s on the lens arrays and spacer are inserted into the holes 311s and 321s in the apertures. With the configuration in which positioning of the lenses and the apertures are implemented by parts with the same shapes as parts of the lenses as described above, it is possible to simultaneously mold the parts to be used for positioning when the lens arrays are molded, and to thereby contribute to the enhancement in the precision of the relative positioning between the lenses and the parts for positioning and to the cutting of the manufacturing costs.

In addition, the description was made of a case in which the holes are formed on the aperture side and the protrusions are formed on the lens array side. However, the present invention is not limited thereto, and it is also suitable that the protrusions are formed on the aperture side and the holes are formed on the lens array side. Moreover, the parts into which the protrusions are inserted are not necessarily holes, and may be formed as concave portions (for example, concave lens shapes).

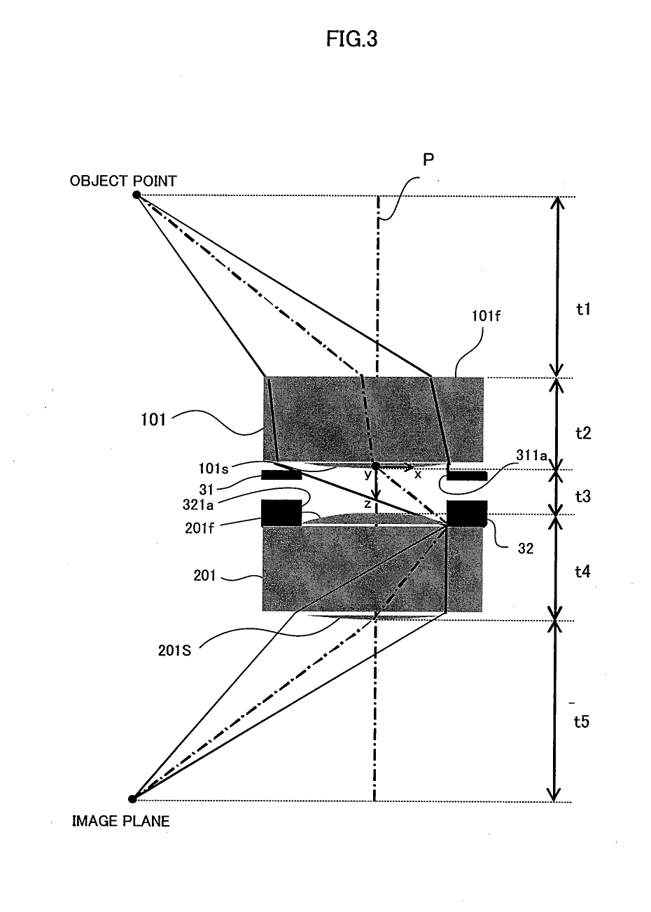

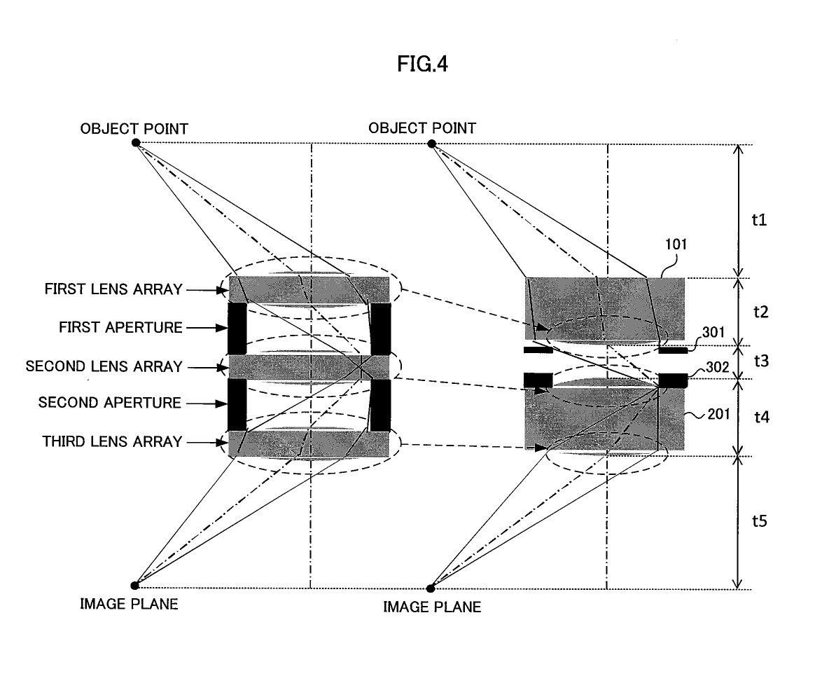

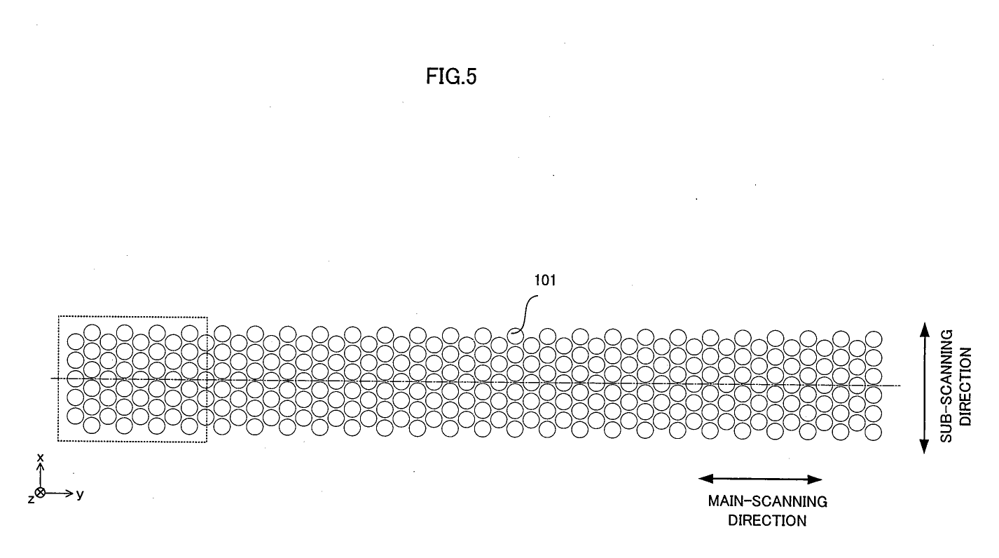

FIG. 3 is a longitudinal sectional view illustrating a configuration of only one pair of optical device group which is aligned along the optical axis of a lens in the erect equal-magnification lens array according to the embodiment. FIG. 4 is a diagram illustrating a relationship between the function of each lens in an erect equal-magnification lens array which uses a combination of three lenses (left diagram) and the configuration of the erect equal-magnification lens array according to the embodiment (right diagram). FIG. 5 is a plan view of an alignment of a plurality of first lenses 101 in the first lens array 1 when seen from above.

The first lens array 1 includes the plurality of first lenses 101. The plurality of first lenses 101 cause light incident from an object point (object plane) to each incidence plane 101f, which has a planar shape or at least a partially planar shape, to be collected in the vicinity of each incidence plane 201f by each outgoing plane 101s which has a convex shape. The plurality of first lenses 101 are aligned in a hexagonal close-packed shape in a direction perpendicular to an optical axis P (see FIG. 5).

The second lens array 2 includes a plurality of second lenses 201. The plurality of second lenses 201 are aligned on a downstream side in a light beam proceeding direction on the optical axis P of each of the plurality of first lenses 101, in a direction perpendicular to the optical axis P so as to correspond to each of the plurality of first lenses 101. The second lenses 201 are provided with incidence planes 201f which have a convex shape and are arranged in the vicinity of a position in the optical axis direction where the light is collected by each of the outgoing planes 101s of the plurality of first lenses 101, and cause the light incident to each of the incidence planes 201f to be collected again on an image plane using the outgoing planes 201s which have a convex shape. Accordingly, the plurality of second lenses 201 are also aligned in a hexagonal close-packed shape in the direction perpendicular to the optical axis P (see FIG. 5).

The first aperture 31 and the second aperture 32 shield light, from among the light collected by each of the outgoing planes 101s of the plurality of first lenses 101, proceeding in a direction to be incident from each of the outgoing planes 1015 to the incidence planes 201f of the second lenses 201 other than the second lenses 201 on the same optical axis.

As described above, the erect equal-magnification lens array of this embodiment is configured to combine the functions of two planes of the incidence plane and the outgoing plane of each lens array in the configuration in which three lens arrays are used and to implement the functions of two planes by one plane. With such a configuration, the minimum number of necessary lens planes becomes three, and it is possible to allow two lens arrays to function in the same manner as three lens arrays (see FIG. 4).

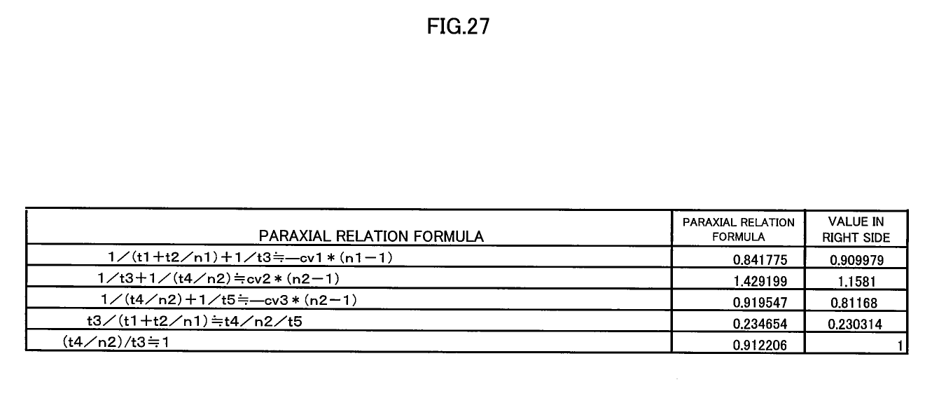

If the incidence plane 101f of the first lens 101 has a planar shape, and when t1 represents the distance from the object point to the incidence plane 101f of the first lens 101, t2 represents the thickness of the first lens 101, t3 represents the distance between the first lens 101 and the second lens 201, t4 represents the thickness of the second lens 201, t5 represents the distance from the outgoing plane 201s of the second lens 201 to the image plane, n1 represents a refraction index of the first lens 101, n2 represents a refraction index of the second lens 201, cv1 represents a curvature of the outgoing plane 101s of the first lens 101, cv2 represents a curvature of the incidence plane 201f of the second lens 201, and cv3 represents a curvature of the outgoing plane 201s of the second lens 201, the following formula is satisfied based on an image forming formula of a paraxial property (see FIG. 27, which will be described later).

1/(t1+t2/n1)+1/t3≈−cv1*(n1−1) (Formula 1)

At this time, cv is expressed with plus (+) when a center of the curvature is positioned on the downstream (image plane) side of the optical path as compared with an intersection of the optical axis P and the lens plane and expressed with minus (−) when the center of the curvature is positioned on the upstream (object point) side of the optical path. As can be understood from the above formula, cv1 becomes a minus (−) value since t1, t2, n1, t3, and (n1−1) are plus (+) values. This means that the lens plane has a convex shape.

The first lens 101 on the incidence plane 101f side is formed in a “planar shape” for the following reason: if a lens plane with power is formed on the incidence plane, it is necessary to use only the light which passes through both a lens formed on the incidence plane and a lens formed on the outgoing plane. Accordingly, it becomes necessary to shield a part of the light entering to the lens effective region on the incidence plane, and as a result, the light amount is decreased. On the other hand, if the incidence plane side is formed in a planar shape, it is possible to set the amount of light passing through the first lens by only the effective region of the lens on the outgoing plane side. Accordingly, a “region in which the light reaching the image plane passes” in the incidence plane 101f of the first lens 101 is formed in a planar shape.

In addition, in order to increase the amount of the light which forms an image on the image plane, the incidence plane 201f of the second lens 201 has a power so as to establish a conjugate relationship between a second main point (which is a main point on the image side and positioned in the vicinity of the outgoing plane 101s) of the first lens 101 and the outgoing plane 201s of the second lens 201.

Specifically, the incidence plane 201f of the second lens 201 is suitable as long as the incidence plane 201f has the following property based on the image forming formula of the paraxial property (see FIG. 27, which will be described later).

1/t3+1/(t4/n2)≈cv2*(n2−1) (Formula 2)

With this configuration, the light outgoing from the outgoing plane 101s of the first lens 101 can be guided to be incident to the effective region in the outgoing plane 201s of the second lens 201 which is positioned on the same optical axis without allowing the light to be incident to the incidence plane 201f side of the second lens 201 which is positioned on a different optical axis.

Since t3, t4, n2, and (n2−1) are plus (+) values, the cv2 becomes a plus (+) value. This means that the lens plane has a convex shape.

Equal-magnification is preferable based on the idea that the outgoing plane 101s of the first lens 101 and the outgoing plane 201s of the second lens 201 are allowed to have the same values with opposite signs to offset the spherical aberration, the comatic aberration, the astigmatism, and the distortion aberration. However, since the aberration also occurs in practice in the optical path between the outgoing plane 101s of the first lens 101 and the incidence plane 201f of the second lens 201, the image height at the outgoing plane 201s of the second lens 201 may be higher than that at the outgoing plane 101s of the first lens 101. If the magnifications at the outgoing plane 101s of the first lens 101 and at the outgoing plane 201s of the second lens 201 are not more than 1 by a small amount, it is possible to prevent the stray light which occurs because the light which passed through the incidence plane 201f of the second lens 201 is incident to the lens on the next column at the outgoing plane 201s of the second lens 201, and it is also possible to prevent the light from being shielded at the aperture when the aperture is positioned in the vicinity of the outgoing plane 201s of the second lens 201.

For this reason, it is preferable to satisfy the following formula from the viewpoints of securing the light amount and preventing the stray light (see FIG. 27, which will be described later).

(t4/n2)/t3<1 (Formula 3)

The outgoing plane 201s of the second lens 201 causes the light from the incidence plane 201f side of the second lens 201 to be collected in the image plane. The outgoing plane 201s of the second lens 201 is suitable as long as it has the following property based on the image forming formula of the paraxial property (see FIG. 27, described later).

1/(t4/n2)+1/t5≈−cv3*(n2−1) (Formula 4)

Since t4, n2, t5, (n2−1) are plus (+) values, cv3 becomes a minus (−) value. This means that the lens plane has a convex shape.

According to this embodiment, the outgoing plane 101s of the first lens 101, the incidence plane 201f of the second lens 202, and the outgoing plane 201s of the second lens 201, which have the power, are formed as aspherical shapes. Forming all the planes as aspherical shapes contributes to the enhancement of the MTF (Modulation Transfer Function).

It is possible to exert a great effect in correcting mainly the spherical aberration and the comatic aberration by forming the outgoing plane 101s of the first lens 101 and the outgoing plane 201s of the second lens 201 as aspherical shapes.

In addition, it is possible to exert an effect of reducing the distortion aberration by forming the incidence plane 201f of the second lens 201 as an aspherical shape.

The magnification of the inverted image at the first lens array 1 is set to be substantially the same as the reciprocal of the magnification at which the inverted image is projected to an erected image at the second lens 201. That is, the magnification from the object point to the incidence plane 201f of the second lens 201 and the magnification from the incidence plane 201f of the second lens 201 to the image plane are in a reciprocal relationship.

Accordingly, the following conditional formula is satisfied in the erect equal-magnification lens array Q according to this embodiment (see FIG. 27, which will be described later).

t3/(t1+t2/n1)≈t4/n2/t5 (Formula 5)

According to this embodiment, the spherical aberration, the comatic aberration, the astigmatism, and the distortion aberration are made to occur in the same amounts with opposite signs at the outgoing plane 101s of the first lens 101 and the outgoing plane 201s of the second lens 201, and thereby made to be offset.

Specifically, it is preferable that the magnification from the outgoing plane 101s of the first lens 101 to the outgoing plane 201s of the second lens 201 is less than 1 (equal magnification) in order to allow the light outgoing from the outgoing plane 101s (corresponding to the object point) of the first lens 101 to be within the outgoing plane 201s of the second lens 201. For this reason, a configuration is made so as to satisfy the following formula in order to set the magnification to be 1 (see FIG. 27, which will be described later).

(t4/n2)/t1≈1 (Formula 6)

In addition, since the aberration remains in practice, the image height at the outgoing plane 201s of the second lens 201 may be higher than that at the outgoing plane 101s of the first lens 101.

By setting this magnification to be not more than 1 by a small amount, it is possible to prevent the “stray light” which occurs because the light which passed through the incidence plane 201f of the second lens 201 is incident to the lens corresponding to the next optical axis at the outgoing plane 201s of the second lens 201 and to prevent the “mechanical vignetting of the light beam” due to an aperture when the aperture is provided in the vicinity of the outgoing plane 201s of the second lens 201.

For this reason, it is preferable to satisfy the following formula from the viewpoints of (1) securing the light amount and (2) suppressing the stray light.

(t4/n2)/t3<1 (Formula 7)

The solution obtained by setting the initial value and optimizing the value from the above paraxial condition will be shown later.

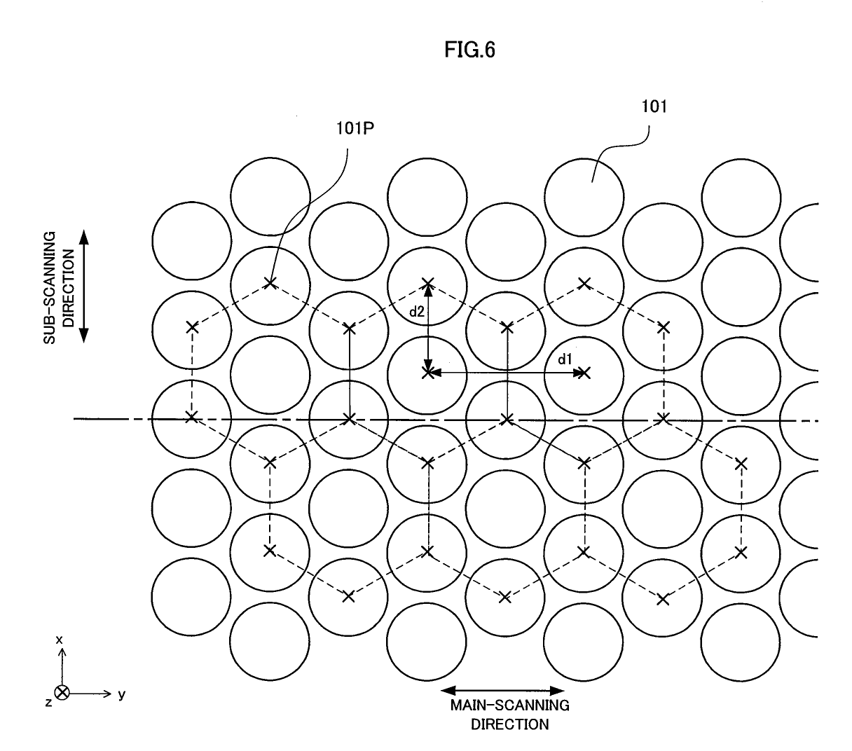

As shown in FIGS. 5 and 6, the first lenses 101 and the second lenses 201 are arranged to be “hexagonal close-packed shape” on a plane which is perpendicular to the optical axis. In addition, if a direction in which line sensors or light emitting points of a light source are aligned is referred to as a “main-scanning direction”, the first lenses 101 and the second lenses 201 are arranged such that a distance d1 between the centers of the lenses in the main-scanning direction is longer than a distance d2 between the centers of the lenses in the sub-scanning direction.

This means that the alignment is made such that the lens alignment number in a first direction (d1 direction), where the distance between the centers of the adjacent lenses is the longest, is more than the lens alignment number in a second direction (d2 direction) which is perpendicular to the first direction.

Since it is possible to broaden the area in which the stray light can be shielded by the incidence planes and the side walls of the apertures when the distances between the centers of the lenses are long, the lenses are arranged in the hexagonal close-packed shape in which the lenses are most effectively arranged, and the direction, where the distances between the lenses are long, is made to correspond to the main scanning direction when the lenses are aligned in the hexagonal close-packed shape. According to this embodiment, a configuration is employed in which the lenses are not arranged in a region where the stray light occurs in the direction in which the distances between the centers of the lenses are short (direction of d2) and the stray light easily occurs.

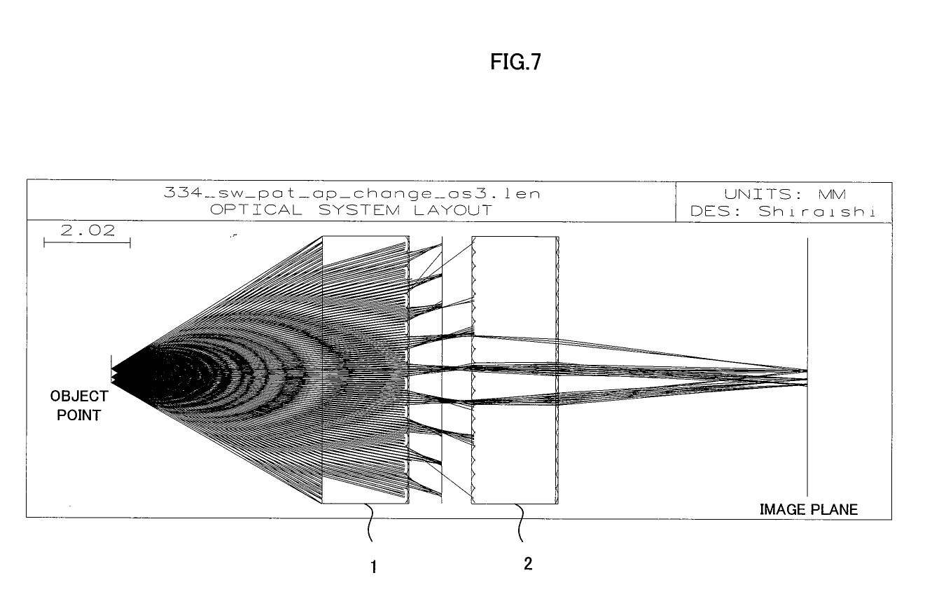

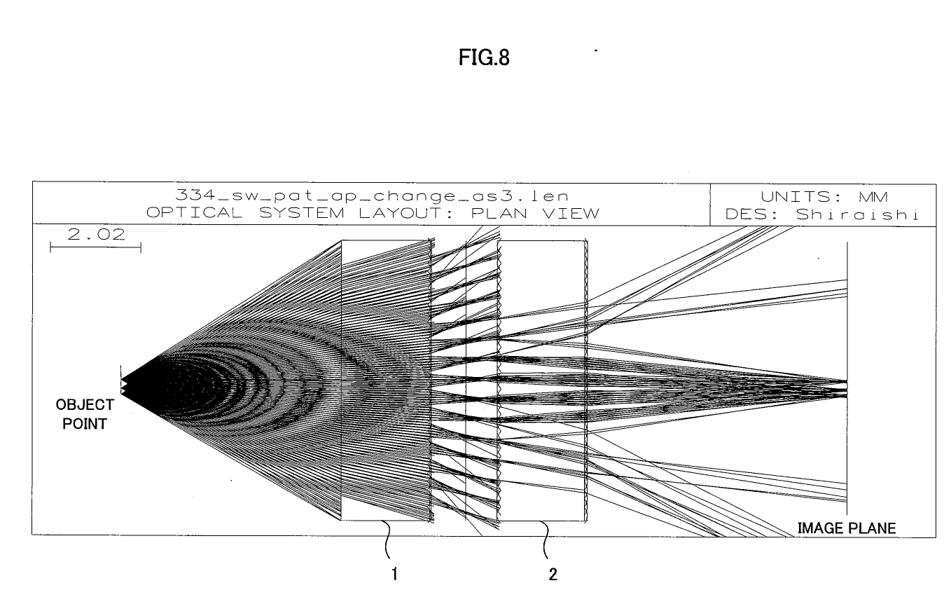

The light amount is maximized, and SAG amount is suppressed by setting the effective diameter of the lens to be the same as the minimum value of the distances between centers of the lenses. FIG. 7 is a diagram illustrating a state in which the light passes when the first lenses 101, the second lenses 201, and holes in the first aperture 31 and the second aperture 32 are aligned in a direction shown in FIG. 5. FIG. 8 is a diagram illustrating a state in which the light passes when the first lenses 101, the second lenses 201, and the holes in the first aperture 31 and the second aperture 32 are aligned in a direction perpendicular to the positional relation in FIG. 5.

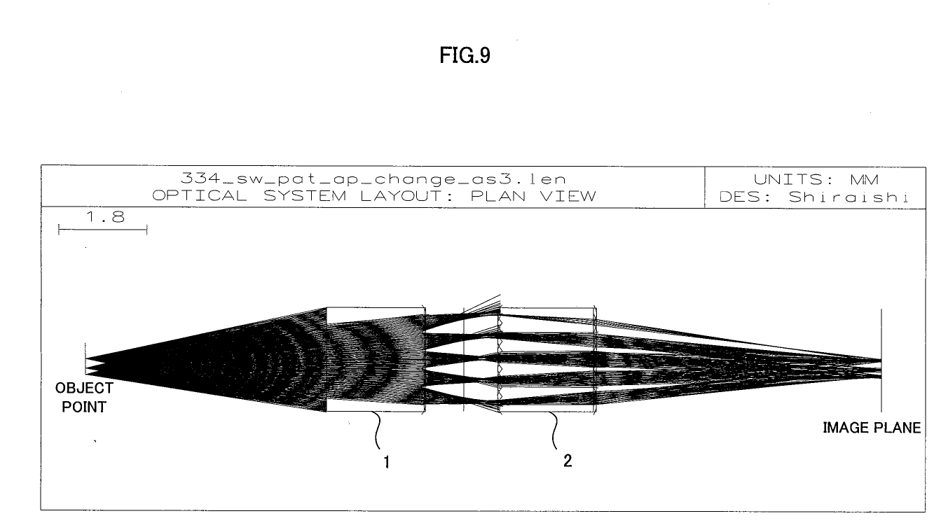

As shown in FIG. 9, it can be understood that the occurrence of the stray light can be suppressed by setting the direction of FIG. 8 to be the direction in which the number of the lens alignment columns is smaller.

In this case, it can be understood that the occurrence of the stray light in the erect equal-magnification lens array Q can be suppressed since the sub-scanning direction is in the state shown in FIG. 9 and the main-scanning direction is in the state shown in FIG. 7.

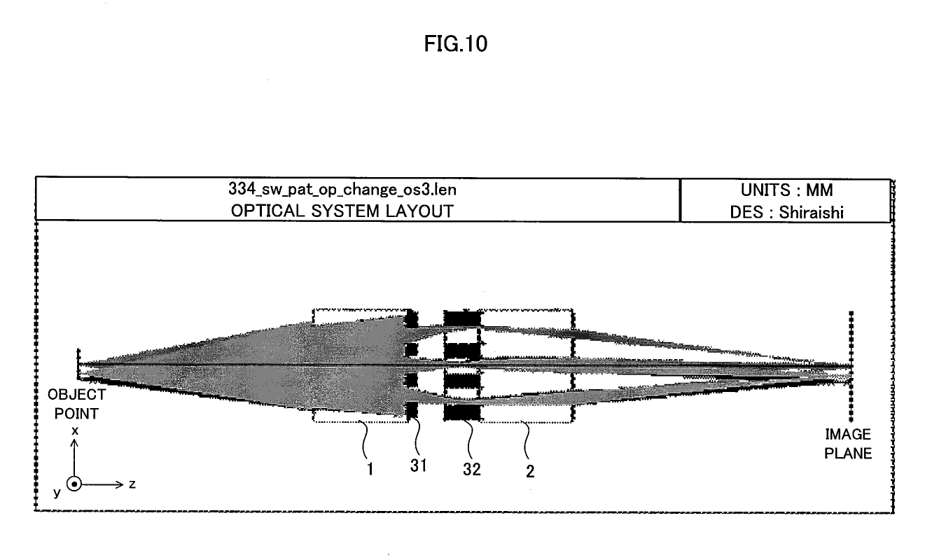

FIG. 10 is a sectional view in a sub-scanning direction, which shows the first aperture 31 and the second aperture 32 of the erect equal-magnification lens array Q according to the embodiment. In the same drawing, the left side corresponds to the object side (original document plane), and the right side corresponds to the image plane (sensor plane).

The incidence plane 201f of the second lens 201 has a power so as to establish a conjugate relationship between a second main point (which is a main point on the image plane side and positioned in the vicinity of the outgoing plane 101s) of the first lens 101 and the outgoing plane 201s of the second lens 201 so as to allow as much of the light as possible which passed through the first lens 101, the first aperture 31 and the second aperture 32 to pass toward the outgoing plane 201s of the second lens 201.

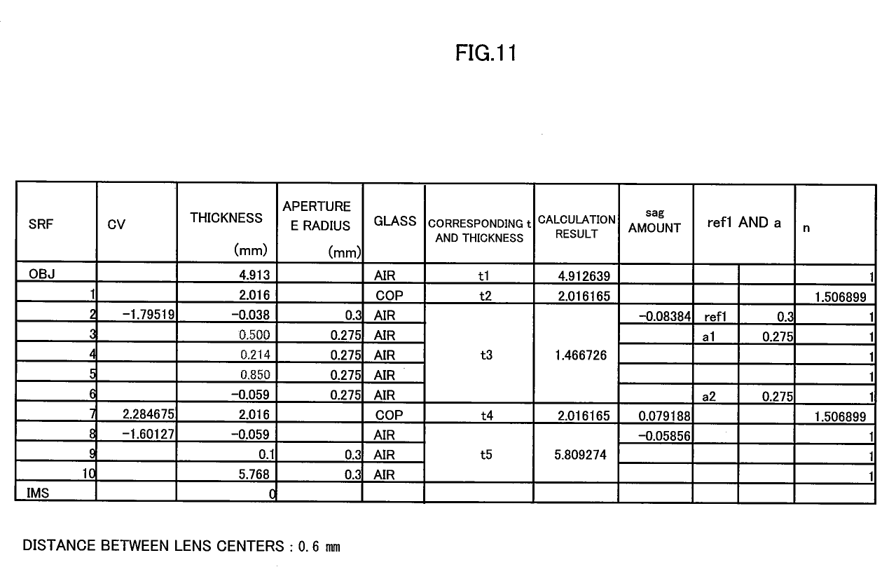

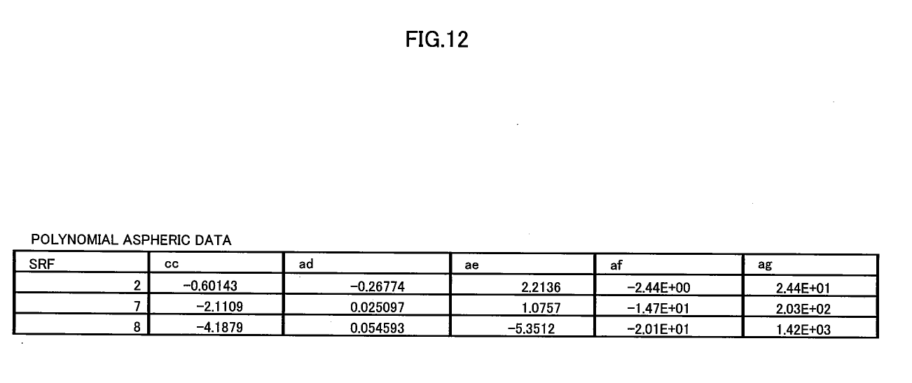

FIG. 11 shows lens data of the erect equal-magnification lens array according to the embodiment. FIG. 12 shows aspherical coefficients of the lens plane in the erect equal-magnification lens array according to the embodiment.

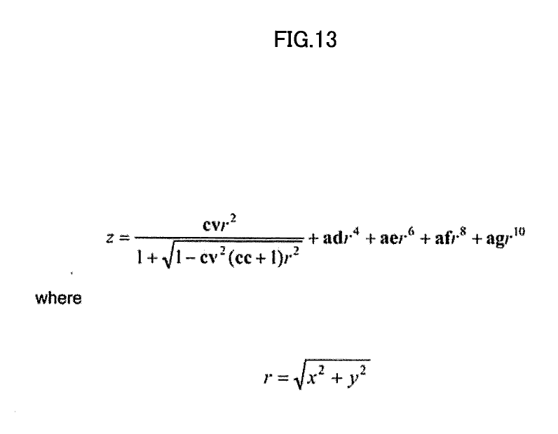

Here, an aspherical formula is represented by the formula shown in FIG. 13 (see FIG. 3 for the coordinate system).

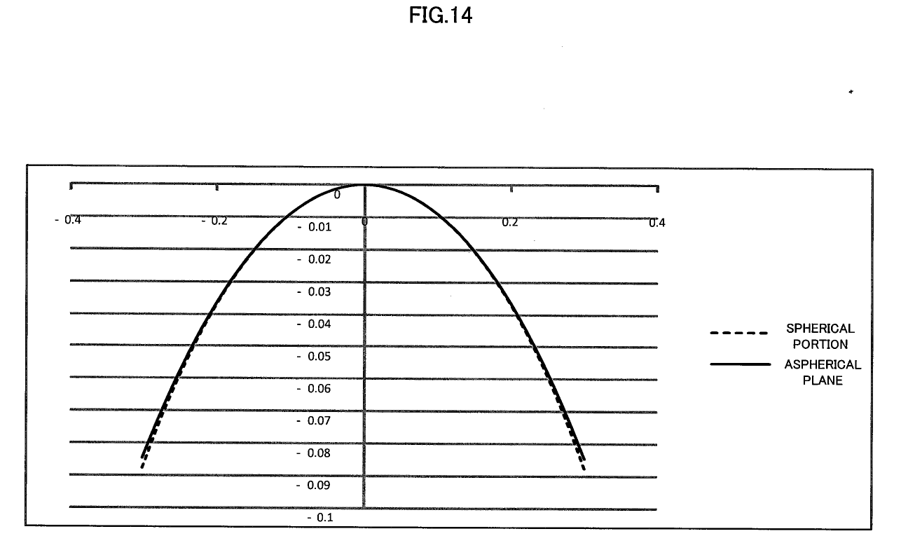

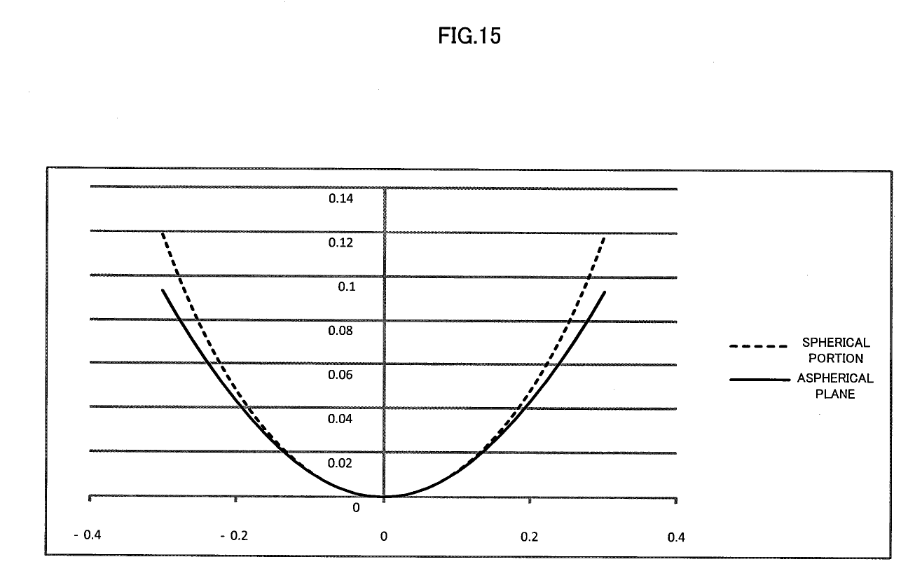

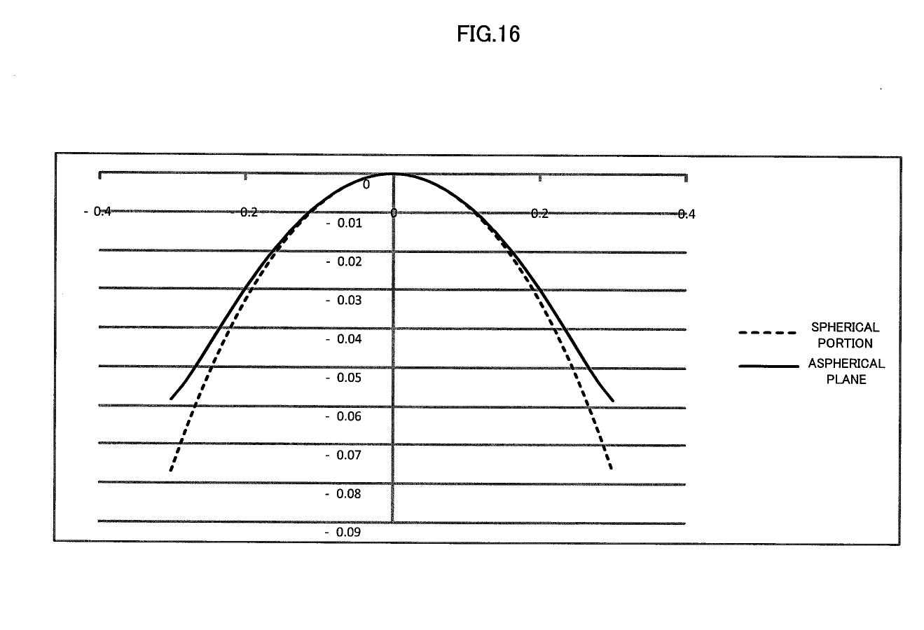

FIG. 14 shows a shape of a spherical portion of the outgoing plane 101s of the first lens 101 by a dotted line and a shape including an aspherical term by a solid line. In FIG. 14, the horizontal axis represents a distance from the optical axis of the individual lens (√(x²+y²) in a local coordinate system shown in FIG. 3 in which the intersection between each lens and the optical axis is set to be the origin), and the vertical axis represents the height (z in the local coordinate system shown in FIG. 3 in which the intersection between each lens and the optical axis is set to be the origin). FIG. 15 shows a shape of a spherical portion of the incidence plane 201f of the second lens 201 by a dotted line and a shape including an aspherical term by a solid line. FIG. 16 shows a shape of a spherical portion of the outgoing plane 201s of the second lens 201 by a dotted line and a shape including an aspherical term by a solid line. The shapes shown by the dotted lines in FIGS. 14 to 16 represent aspherical shape when the condition of the aspherical formula shown in FIG. 13 is assumed to be “cc=ad=ae=af=ag=0”. As for the shapes including the aspherical terms shown by the solid lines in FIGS. 14 to 16, all the lens planes have aspherical shapes in which the absolute values of the curvatures become smaller in the direction toward the outside (periphery side) of the centers (optical axes P) of the lenses.

When a completely symmetrical optical system in which both the first and second lenses have equal magnification is employed, the distortion aberration, the comatic aberration, and the chromatic aberration due to the magnification do not occur. However, when the configurations of the first and second lenses are different as in this embodiment, the distortion aberration and the comatic aberration occur as long as nothing is made for preventing such aberrations. Particularly, there is a concern that the magnification increases along with the image height, and thereby the light beams from the plurality of lens arrays cannot be collected satisfactorily in the lens arrangement according to this embodiment. Accordingly, while the arrangement of the optical devices as in this embodiment is employed, the outgoing plane 101s of the first lens 101, the incidence plane 201f of the second lens 201, and the outgoing plane 201s of the second lens 201 are formed as aspherical planes in which the absolute values of the curvatures become smaller in the direction toward the outside of the centers of the lenses in order to suppress the occurrence of the distortion aberration and the comatic aberration.

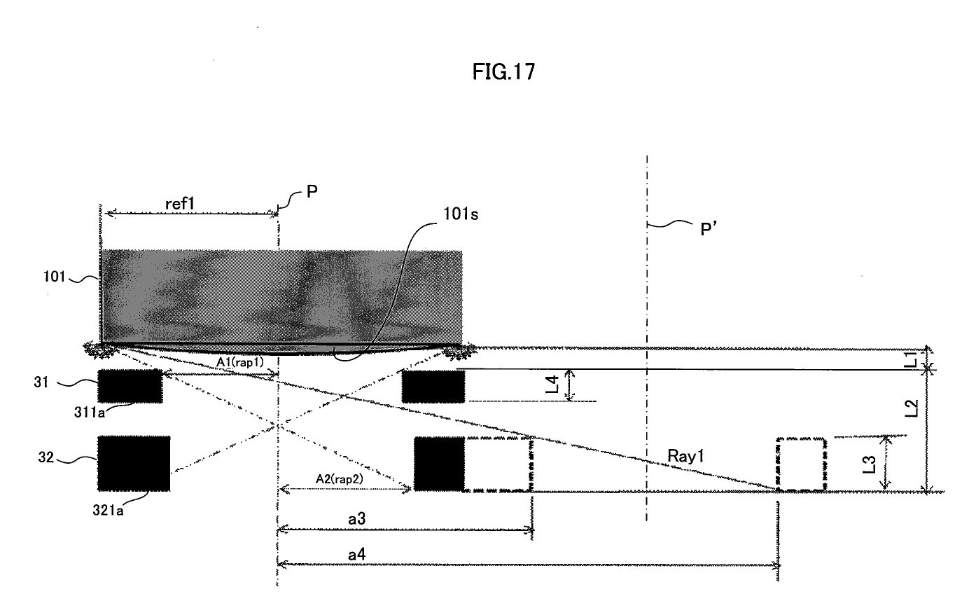

The minus amount of SRF2 thickness in FIG. 11 shows that the first aperture 31 is arranged in a direction in which the first aperture 31 gets into the lens by 0.038 mm when seen from the lens apex of the outgoing plane 101s of the first lens 101. That is, it can be understood that there is a gap between the edge of the lens and the plane on the lens side of the first aperture 31 since the amount is smaller than the SAG amount 0.08384 mm (corresponding to L1 in FIG. 17, which will be described later). By appropriately setting this gap amount, it is possible to increase the light amount without allowing the scattering light from the lens edge to reach the second lens 201.

A description will be made of this condition using FIG. 17. FIG. 17 shows the first lens 101, the first aperture 31, and the second aperture 32. The light beam proceeds from the upper side to the lower side.

When the center of a round hole 311a in the first aperture 31 is concentric with the optical axis P of the first lens 101 and the radius of the round hole 311a is rap1, and when a round hole 321a in the second aperture 32 is deviated from the optical axis P of the first lens 101 by a maximum of δap2 and the radius of the round hole 321a is rapt, the condition, whereby the stray light does not enter into the round hole 321a of the second aperture 32 which is positioned on the same optical axis as that of the first lens 101, is that the light beam with a maximum inclination L1/(ref1−rap1) of the light beam which passes from the lens edge to the entrance of the first aperture 31 is required to be smaller than a minimum inclination L2/(rap1+rap2+δap2) of the light beam which can pass through the incidence side of the first aperture 31 and the outgoing side of the second aperture 32.

Accordingly, it is necessary to satisfy the following formula.

L1/(ref1−rap1)<L2/(rap1+rap2+δap2) (Formula 8)

This formula can be arranged as follows.

L1<(ref1−rap1)/(rap1+rap2+δap2)×L2 (Formula 9)

In the above formula, the holes formed in the apertures were assumed to have round shapes, and the diameters were defined as rap1 and rap2. On the other hand, when the holes formed in the apertures do not have round shapes, and it is assumed that a1 represents a distance from the optical axis P to a position in the hole in the first aperture 31 on the side of the first lens 101, which is positioned furthest from the optical axis P, and a2 represents a distance from the optical axis P to a position in the hole in the second aperture 32 on the side of the second lens 102, which is positioned furthest from the optical axis P, the above formula can be changed to

L1<(ref1−a1)/(a1+a2+δap2)×L2 (Formula 9′)

by replacing rap1 in (Formula 9) with a1 and replacing rap2 with a2. When δap2=0, the above formula can be changed to

L1<(ref1−a1)/(a1+a2)×L2 (Formula 9″)

Although two apertures are employed here, the same condition can be used even when these two apertures are combined and only one aperture is used. In such a case, it is possible to apply the same formula if it is assumed that rap1 represents the radius of the hole in the aperture on the side of the first lens plane, rap2 represents the radius of the hole in the aperture on the side of the second lens plane, and δap2 represents the eccentric at each side of the aperture.

The condition formula, whereby it is possible to prevent the light outgoing from the outgoing plane 101s of the first lens 101 along an optical axis P from being incident as the stray light to the round hole 321a of the second aperture 32 aligned along an optical axis P′ which is different from the optical axis of the first lens (see FIG. 17) when the first aperture 31 and the second aperture 32 are individually independently arranged in the optical axis direction, is as follows based on the same idea as that described above.

(L1+L2)/(a4+ref1)>(L1+L2−L3)/(a3+ref1) (Formula 10)

Here, ref1 represents the radius of an inscribed circle of the lens effective portion of the first lens 101 (the diameter whose distance from the optical axis is the shortest or the radius of the lens effective portion, from among the outer periphery of the lens), L1 represents the distance in the optical axis direction from the lens outer peripheral edge of the first lens 101 to the edge of the hole 311a of the first aperture 31 which is closest to the first lens 101, L2 represents the distance in the optical axis direction from the plane of the first aperture on the side of the first lens 101 to the plane of the second aperture 32 on the side of the second lens 201, L3 represents the thickness of the second aperture 32 in the optical axis direction, a3 represents the shortest distance from the optical axis of the first lens 101 to the inner peripheral plane of the hole 321a in the second aperture 32 which is formed so as to correspond to another first lens 101 adjacent to the above first lens 101, and a4 represents the longest distance from the optical axis of the first lens 101 to the inner peripheral plane of the hole in the second aperture 32 which is formed so as to correspond to another first lens 101 adjacent to the above first lens 101. Here, Formula 10 can be changed as follows.

L3>(a4−a3)/(a4+ref1)×(L1+L2) (Formula 11)

The configuration, whereby the plurality of second lenses are arranged on the downstream side in the light beam proceeding direction on the optical axis of each of the plurality of first lenses in a direction perpendicular to the optical axis so as to correspond to each of the plurality of first lenses and the incidence planes which have convex shapes are arranged in the vicinity of a position in the optical axis direction, at which the light is collected by the respective outgoing planes of the plurality of first lenses, means, in other words, that the object point and the incidence plane 201f of the second lens 201 are conjugate.

In addition, the configuration, whereby the respective incident light beams are collected again on the image plane by the outgoing plane 201s which has a convex shape, means, in other words, that the incidence plane 201f of the second lens 201 and the image plane are conjugate.

Hereinafter, with reference to FIG. 11, a description will be made of the fact that the thickness L3 of the second aperture 32 with which the stray light is prevented from occurring is different depending on the direction in which the lenses are aligned in the hexagonal close-packed shape.

When the aperture is manufactured by overlapping thin sheets with holes formed therein, or when the aperture is manufactured by performing printing repeatedly several times to overlap the printing, the number of times for overlapping is decreased and the cost can be reduced if the thickness of the aperture is thin. Here, it is assumed that δap2=0, and the hole diameter of the hole 321a of the second aperture 32 is rap2 at both the side of the incidence plane and the side of the outgoing plane.

First, it is assumed that the lenses and the apertures have infinite sizes in both the main-scanning direction and the sub-scanning direction.

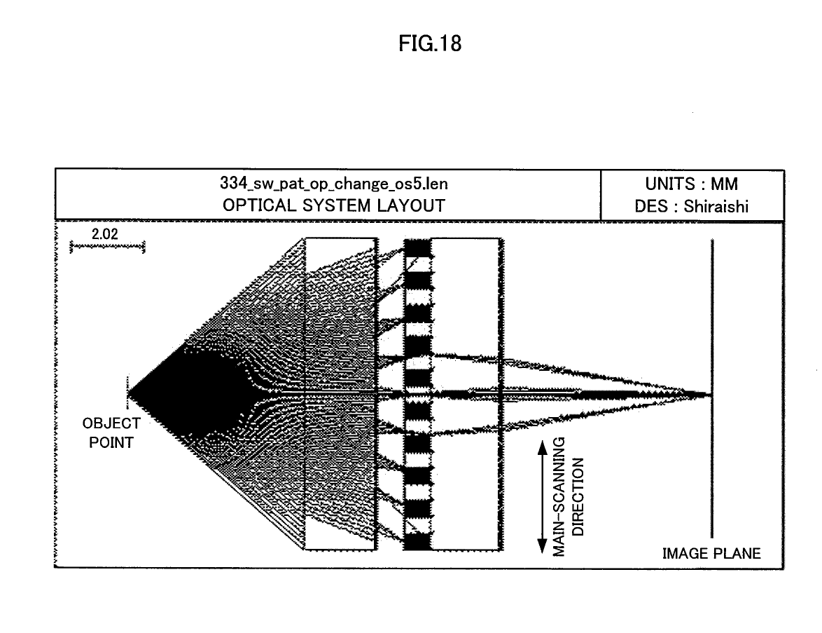

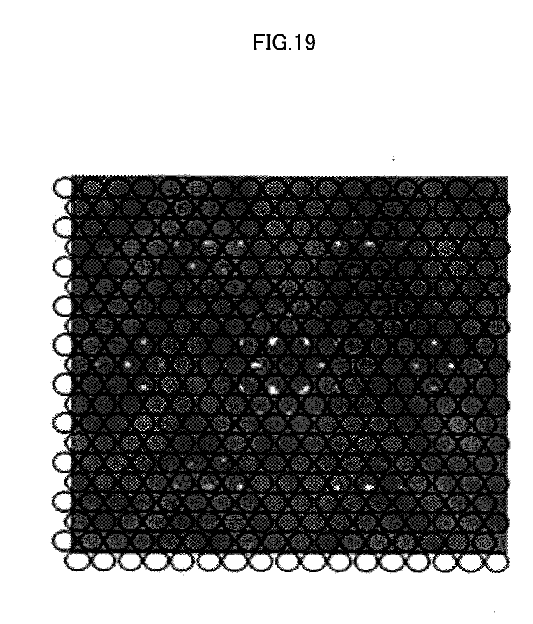

FIG. 18 is a sectional view of the erect equal-magnification lens array Q in the main-scanning direction in which pitches between lenses are maximized. FIG. 19 is a diagram illustrating an illuminance distribution in the incidence plane 201f of the second lens 201 in the state in FIG. 18 when the board thickness of the second aperture 32 is set to be 0.85 mm. At this time, since the distance between the centers of the lenses in the main-scanning direction is √3×p when p represents the shortest distance between the lenses, the following equation is satisfied.

a3=√3×p−rap2, a4=√3×p+rap2 (Formula 12)

If Formula 12 is substituted into Formula 11, the following formula is established.

L3>(2×rap2)/(√3×p+rap2+ref1)×(L1+L2) (Formula 13)

That is, L3>0.548 is satisfied in the case of the lens data shown in FIG. 11.

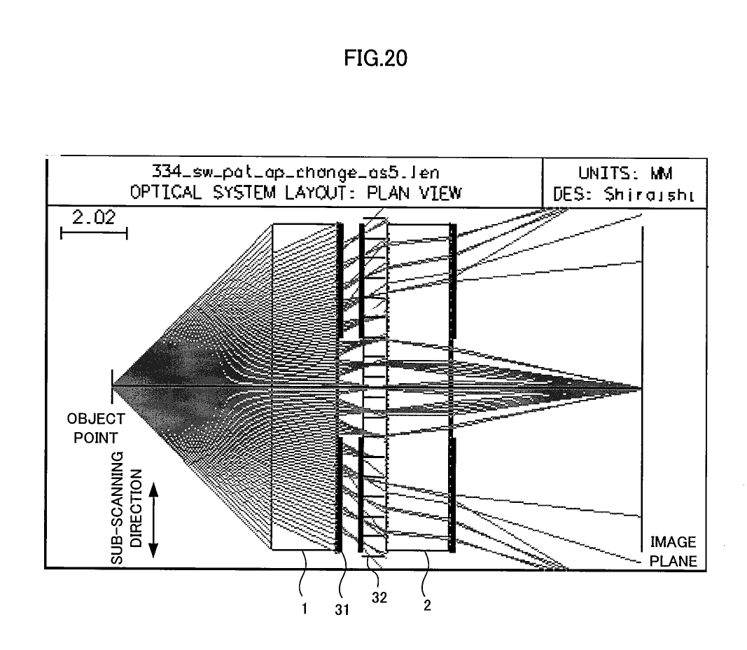

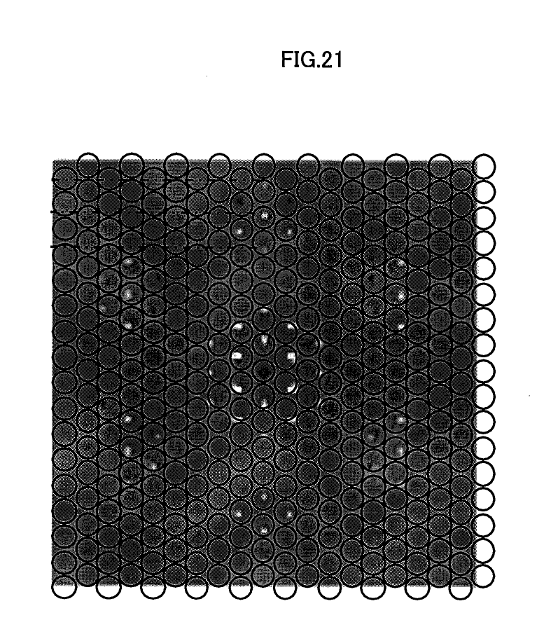

FIG. 20 is a sectional view in the sub-scanning direction in which the pitches between lenses are minimized. FIG. 21 shows an illuminance distribution in the incidence plane 201f of the second lens 201 in the state in FIG. 20 when the board thickness of the second aperture 32 is set to be 0.85 mm.

At this time, since the distance between the centers of the lenses in the sub-scanning direction becomes p when p represents the shortest distance between the lenses, the equations of a3=p−rap2 and a4=p+rap2 are satisfied. If these are substituted into Formula 11, the following equation is established.

L3>(2×rap2)/(p+rap2+ref1)×(L1+L2) (Formula 14)

That is, L3>0.754 is satisfied in the case of the lens data shown in FIG. 11. Here, L3 is set to be 0.85 mm.

The description was made of the condition whereby the stray light from the lens edge enters into the next lens. However, if Formulae 13 and 14 are satisfied in the entire lens plane, the condition whereby the light passing through the first lens plane does not enter into the next lens can be satisfied. This corresponds to the fact that ref1 in Formulae 13 and 14 are allowed to be in the range from −ref1 to ref1.

When ref1 is set to be −ref1, the right sides in Formulae 13 and 14 become largest values.

L3>(2×rap2)/(√3×p+rap2−ref1)×(L1+L2) (Formula 15)

L3>(2×rap2)/(p+rap2−ref1)×(L1+L2) (Formula 16)

In the case of the lens data shown in FIG. 11, L3>0.927 in Formula 15 and L3>1.635 in Formula 16.

That is, when L3>1.635, the light beam does not enter into the next lens array in all directions which are perpendicular to the optical axis regardless of the value of L4.

When 1.635>L3>0.927, the light beam does not enter into the next lens array in the direction in which the pitches are the largest regardless of the value of L4. However, the light beam enters to the next lens array and becomes the stray light in the direction in which the pitches are the smallest depending on the value of L4.

When L3<0.927, there is a possibility that the stray light occurs in all directions which are perpendicular to the optical axis depending on the value of L4. As described above, L3 is set to be 0.85 in FIG. 11, the stray light occurs in all directions which are perpendicular to the optical axis depending on the value of L4.

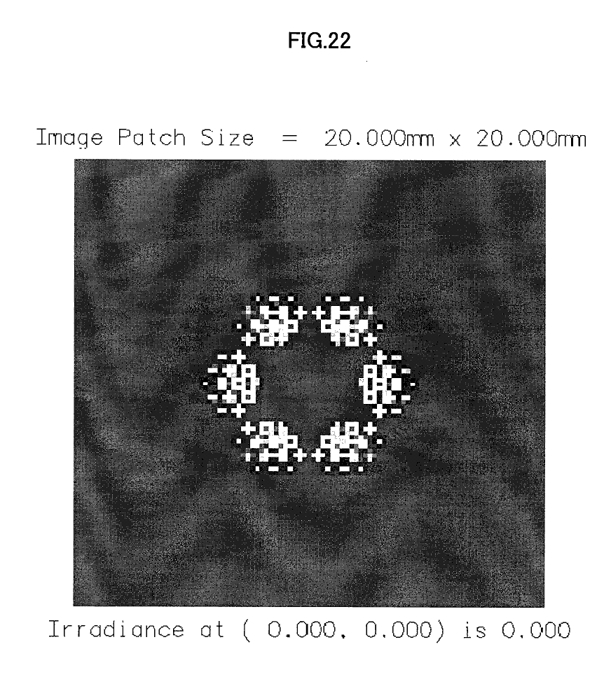

FIG. 22 is a diagram illustrating a state in which stray light occurs in all directions, which are perpendicular to the optical axis, on the incidence plane 201f of the second lens 201 after the light passed through the second aperture 32 (FIG. 22 show the state when L3=0.5 mm and L4=0.1 mm. It can be found that the stray light slightly occurs in the vertical direction (main-scanning direction)).

The condition, whereby Ray 1 shown in FIG. 17 is shielded on the outgoing side of the first aperture 31 when the stray light cannot be shielded only by the second aperture 32, is as follows.

a3−(a4−a3)/L3×(L2−L3−L4)>a1 (Formula 17)

Here, L4 represents the thickness of the first aperture 31 in the optical axis direction. If the above formula is arranged as a formula of the thickness L4 of the first aperture 31, the following formula can be obtained.

L4>(a1−a4)/(a4−a3)×L3+L2 (Formula 18)

When a1 is set to be equal to rap1 in the direction in which the pitches between the lenses are maximized, the following formula can be obtained.

L4>(rap1−√3×p−rap2)/(√3×p+rap2−√3×p+rap2)×L3+L2 (Formula 19)

These formulae can be combined to the following formula:

L4>(rap1−√3×p−rap2)/(2×rap2)×L3+L2 (Formula 20)

When a1 is set to be equal to rap1 in the direction in which the pitches between the lenses are minimized, the following formula can be obtained.

L4>(rap1−p−rap2)/(p+rap2−p+rap2)×L3+L2 (Formula 21)

This can be changed as follows:

L4>(rap1−p−rap2)/(2×rap2)×L3+L2 (Formula 22)

Since the right side in Formula 20 is smaller than the right side in Formula 22, the stray light does not occur in all directions when L4>(rap1−p−rap2)/(2×rap2)×L3+L2 is satisfied. The light beam does not enter into the next lens array in the direction in which the pitches are the largest but the light beam enters to the next lens array in the direction in which the pitches are the smallest and becomes the stray light when the following formula is satisfied.

(rap1−p−rap2)/(2×rap2)×L3+L2>L4>(rap1−√3×p−rap2)/(2×rap2)×L3+L2 (Formula 23)

Here, since the lens width is made small in the sub-scanning direction in practice, it is possible to prevent the stray light from reaching the image plane even in the state where

(rap1−p−rap2)/(2×rap2)×L3+L2>L4>(rap1−√3×p−rap2)/(2×rap2)×L3+L2 (Formula 23)

as long as it is possible to guide the stray light to the region where no lens and hole of aperture exist.

The condition to implement this is that it is necessary to make the direction in which the pitches between the lenses are minimized and the stray light occurs most easily coincide with the sub-scanning direction and to satisfy the following formula.

L4>(rap1−√3×p−rap2)/(2×rap2)×L3+L2 (Formula 20)

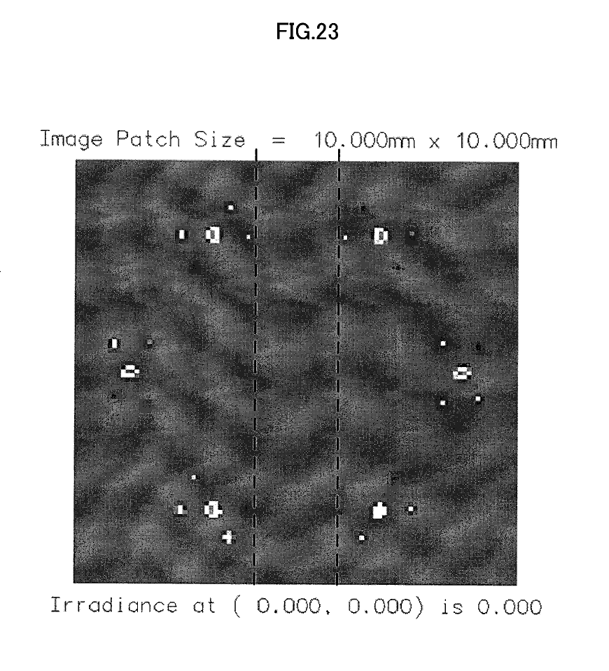

In the case of the lens data shown in FIG. 11, L3=0.85 mm, the right side of Formula 20 is −0.042130833 (the thickness equal to or more than 0 means that no stray light occurs in the main-scanning direction), and the right side in Formula 22 is 0.636679916. Here, since L4 is set to be 0.5 mm, the stray light occurs on the incidence plane 201f of the second lens 201 after the light has passed through the second aperture 32 in the sub-scanning direction while no stray light occurs in the main-scanning direction. This state will be shown in FIG. 23. In FIG. 23, only the stray light is plotted in the state where the original light is shielded. In FIG. 23, the vertical direction corresponds to the main-scanning direction, and the horizontal direction corresponds to the sub-scanning direction. It can be understood from FIG. 23 that the lenses in the sub-scanning direction are not affected by the stray light if the positional range of the lenses is set on the inner side so as to avoid the place where the stray light occurs. The range shown by a broken line in FIG. 23 is an example of the range in which lenses are not affected by the stray light.

In addition, the tendency that it is possible to make the total thickness of the two apertures be thin when the thickness of the second aperture 32 is made to be thicker than that of the first aperture 31 was found as a result of the study of various combinations of the thicknesses and the hole diameters of the first aperture 31 and the second aperture 32.

According to this embodiment, the thickness of the second aperture 32 is set to be thicker than that of the first aperture 31. With such a configuration, it is possible to cut the stray light from the periphery of the lens at the outgoing plane 101s of the first lens 101 while minimizing the costs.

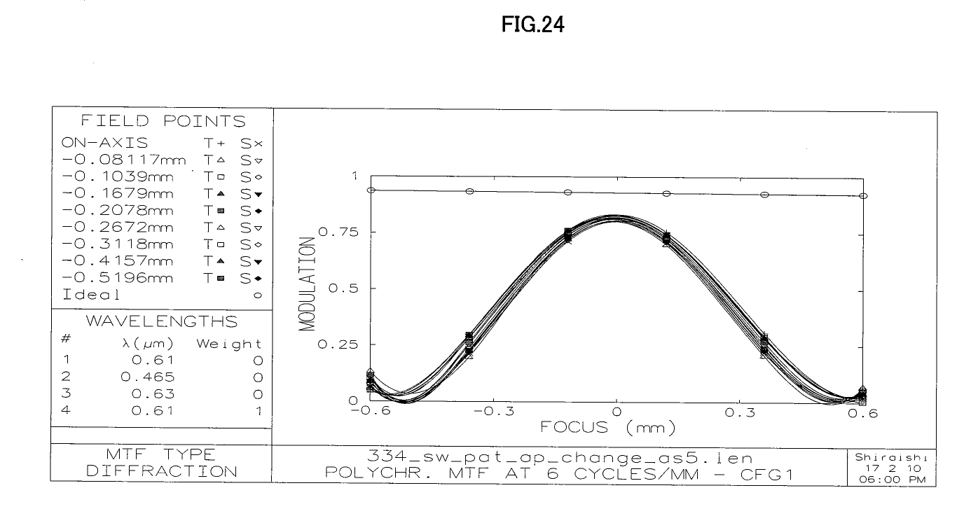

In the case of the lens data shown in FIG. 11, L1<0.056 and L3>0.753 are satisfied when δap2=0. FIG. 24 is a diagram illustrating a defocusing characteristic of MTF at 6 cycle/mm in the state shown in FIG. 11.

In this case, the optical efficiency at the lens plane is 2.242%. The optical efficiency when L1=0 mm, that is, when the first aperture 31 is made to be in contact with the edge of the first lens 101 in the first lens array 1 as in the related art becomes 2.116%, and it can be understood that the light amount is increased by approximately 6% by separating the aperture from the edge of the first lens 101 in the first lens array 1 (setting L1 to be 0.056 mm).

It is possible to improve the light amount by broadening the inner diameter of the round hole 311a in the first aperture 31 up to the lens edge even in the state where the first aperture 31 is made to be in contact with the edge of the first lens 101 in the first lens array 1. However, the light passing through the lens effective plane generates a great amount of stray light when the first lens 101 and the round hole 311a in the first aperture 31 are decentered. On the other hand, when the lens array and the aperture are separated from each other, only a part of the scattering light from the periphery of the first lens 101 is incident to the next second lens 201 at the latter stage and the amount of the stray light which occurs overall is small even if the first lens 101 and the round hole 311a of the first aperture 31 are eccentric.

If the round hole is formed to be excessively large using a punch or the like at the time of manufacturing the aperture, there is a concern that the overall shape as an aperture may be distorted. Accordingly, the configuration of this embodiment, whereby it is possible to increase the light amount without increasing the hole diameter, can contribute to the diversification of the choices for the manufacturing methods.

According to the lens data shown in FIG. 11, when the distance between the centers of the round holes 321a of the second aperture 32 in the sub-scanning direction is set to be 0.66 mm, the lenses up until those arranged from the center position to the second column in the sub-scanning direction are used. Accordingly, the maximum eccentricity becomes (0.66-0.6)*2=0.12. That is, the maximum eccentricity amount becomes δap2=0.12, and L1<0.046 and L3>0.753 are satisfied at this time.

In this case, the light amount, which is increased by setting the pitches between the centers of the round holes 321a in the second aperture 32 in the sub-scanning direction to be larger than the other pitches, is substantially equal to the light amount which is decreased because the value of L1 becomes smaller by adding δap2, and the optical efficiency becomes 2.242%.

Here, the expression of “setting the pitches between the round holes 321a in the second aperture 32 in the sub-scanning direction to be larger than the other pitches” means that the centers of the respective round holes other than the round holes, which are positioned in the center in the sub-scanning direction, from among the plurality of round holes, are located further to the outside in the sub-scanning direction than the center of the corresponding first lens 101.

The case where the hole diameter of the round hole 321a in the second aperture 32 is set to be 0.15 mm in the lens data shown in FIG. 11 will be considered.

The pitches in the first lens array 1 and the second lens array 2 are set to be the same as the pitches between the round holes 311a in the first aperture 31, and the shortest interval is 0.6 mm.

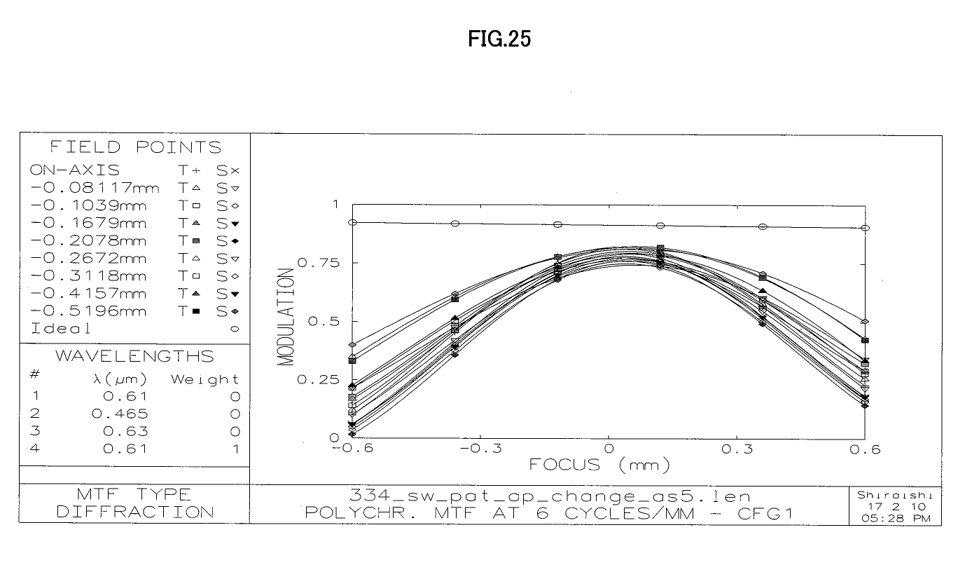

When the pitches between holes in all the components are equally 0.6 mm as described above, L1<0.071 and L3>0.459928286 are satisfied. FIG. 25 shows the defocusing property of the MTF in this case. The optical efficiency at this time is 0.724%.

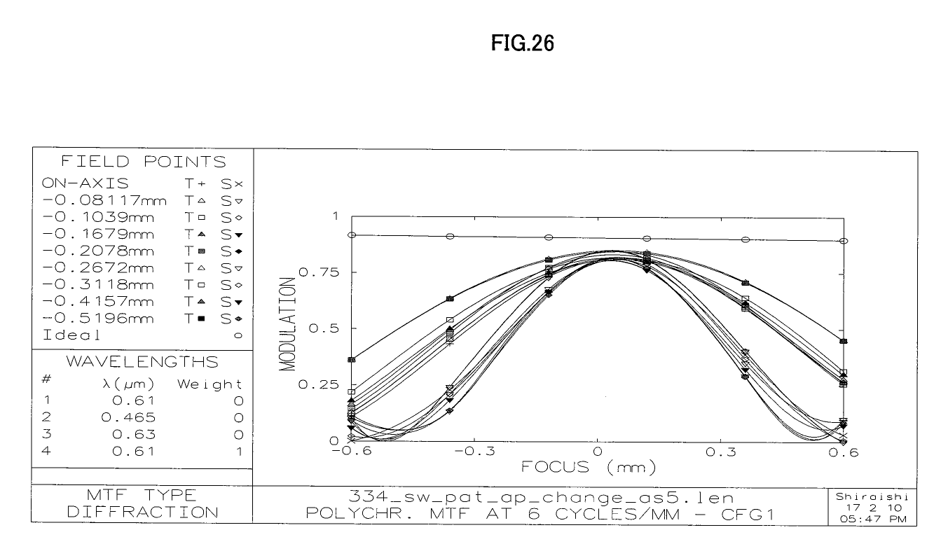

In addition, when it is assumed that the pitches between the round holes 321a in the second aperture 32 are set to be 0.6 mm in the main-scanning direction and 0.66 mm in the sub-scanning direction, the optical efficiency is 1.091%, which is an increase of approximately 50%. FIG. 26 shows the defocusing property of the MTF at this time.

The focus depth in the sub-scanning direction falls to substantially the same extent as that when the hole diameter of the round hole 321a in the second aperture 32 is 0.55 mm. However, since the hole diameter becomes smaller and the width of the wall between the round holes becomes larger, it is possible to significantly suppress the occurrence of the stray light due to the eccentricity of the lens and the aperture as compared with the case when the aperture diameter is large.

FIG. 27 is a diagram showing how the paraxial relation set in the initial setting changed after the optimization of the optical system. There are values which are the same in both the right side and the left side in the initial setting but become different from each other by about 25%. However, the values are basically the ones which are close to the relational equation.

Hereinafter, a consideration will be made regarding the following equation for making the outgoing plane 101s of the first lens 101 and the outgoing plane 201s of the second lens 201 be in the conjugate relation in order to improve the light amount.

(t4/n2)/t3≈1

It is preferable to set the equal magnification based on the idea that the outgoing plane 101s of the first lens 101 and the outgoing plane 201s of the second lens 201 are made to have the spherical aberration, the comatic aberration, the astigmatism, and the distortion aberration in the same amount with the opposite signs to offset these aberrations. However, since the aberration occurs in practice in the optical path from the outgoing plane 101s of the first lens 101 to the incidence plane 201f of the second lens 201, the image height at the outgoing plane 201s of the second lens 201 may be higher than that at the outgoing plane 101s of the first lens 101. If the magnifications at the outgoing plane 101s of the first lens 101 and at the outgoing plane 201s of the second lens 201 are not more than 1 (0.91 in this embodiment) by a small amount, it is possible to prevent the stray light which occurs because the light which passed through the incidence plane 201f of the second lens 201 is incident to the lens aligned along the next optical axis at the outgoing plane 201s of the second lens 201, and it is also possible to prevent the mechanical vignetting at the aperture when the aperture is positioned in the vicinity of the outgoing plane 201s of the second lens 201.

For this reason, it is preferable to satisfy the following formula from the viewpoints of securing the light amount and preventing the stray light.

(t4/n2)/t3<1

As shown in the lowest section in FIG. 27, the left side of the above formula is 0.912206, and is less than 1.

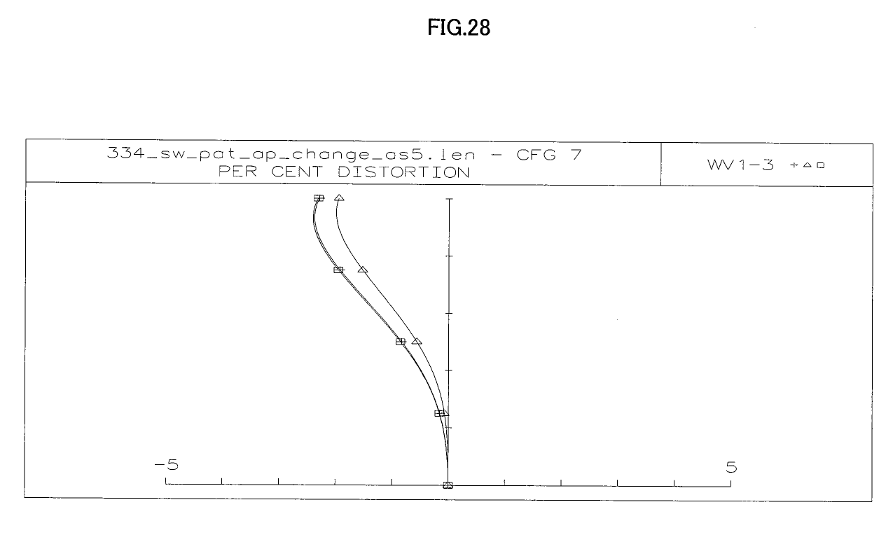

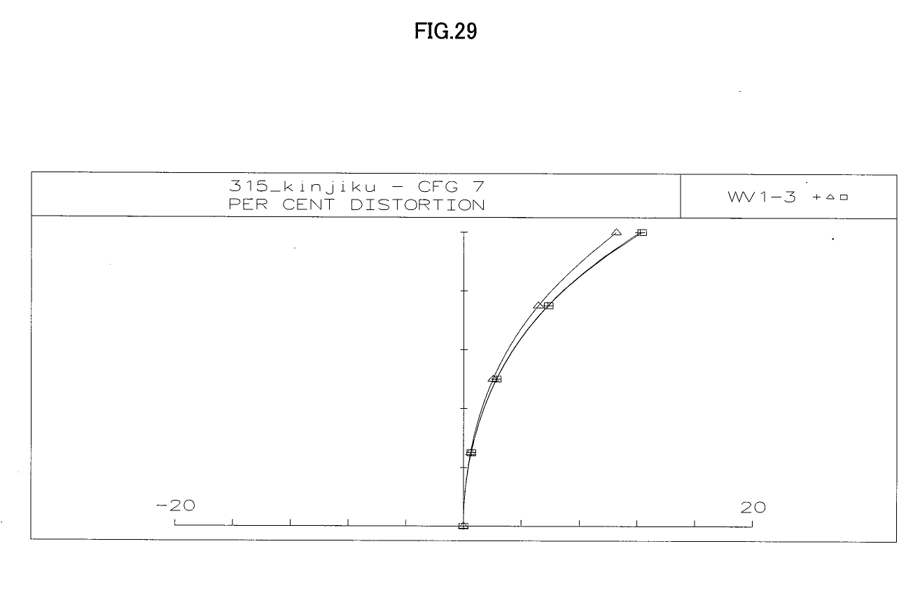

FIG. 28 is a diagram showing distortions of one set of a lens group constituted by the first lens 101 and the second lens 201 which have the lens data shown in FIGS. 11 and 12. FIG. 29 is a diagram showing distortions of one set of a lens group which is optimized in the state where the lens planes are made to be spherical planes.

It can be understood from FIG. 28 that the distortion is improved as compared with the case shown in FIG. 29 by forming the lens plane to be an aspherical shape.

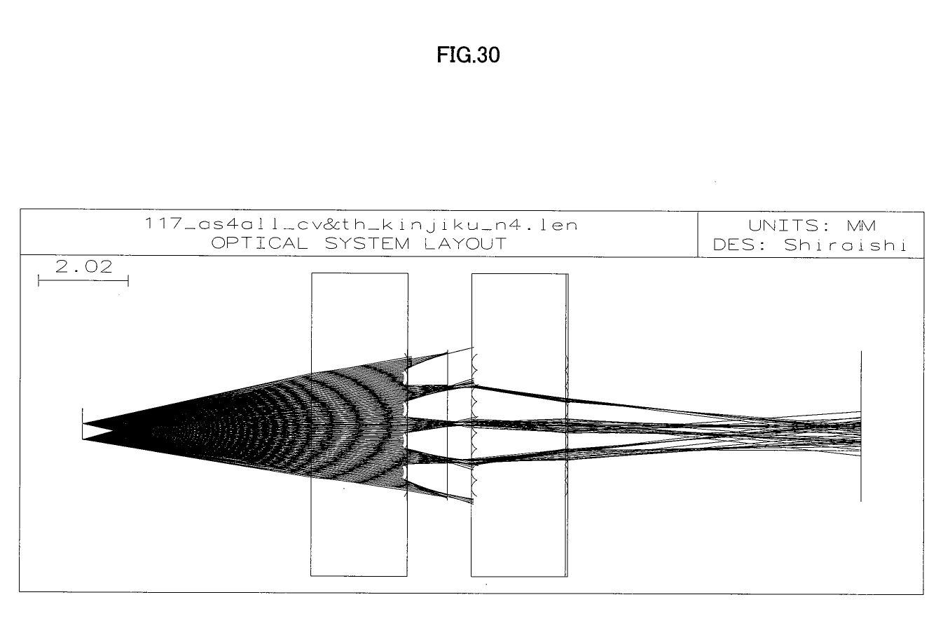

FIG. 30 is a diagram illustrating a state of an optical path when the lens planes of the first lens 101 and the second lens 201 are optimized only at their spherical planes. It can be understood that the light which passed through the respective lens sets forms images at different positions on the image plane since the distortion has a large (+) value.

In the above embodiment, the description was made of the case in which the aperture is configured by two apertures including the first aperture 31 and the second aperture 32. However, the present invention is not necessarily limited thereto. For example, it is also possible to implement the functions of the first aperture 31 and the second aperture 32 as a single aperture.

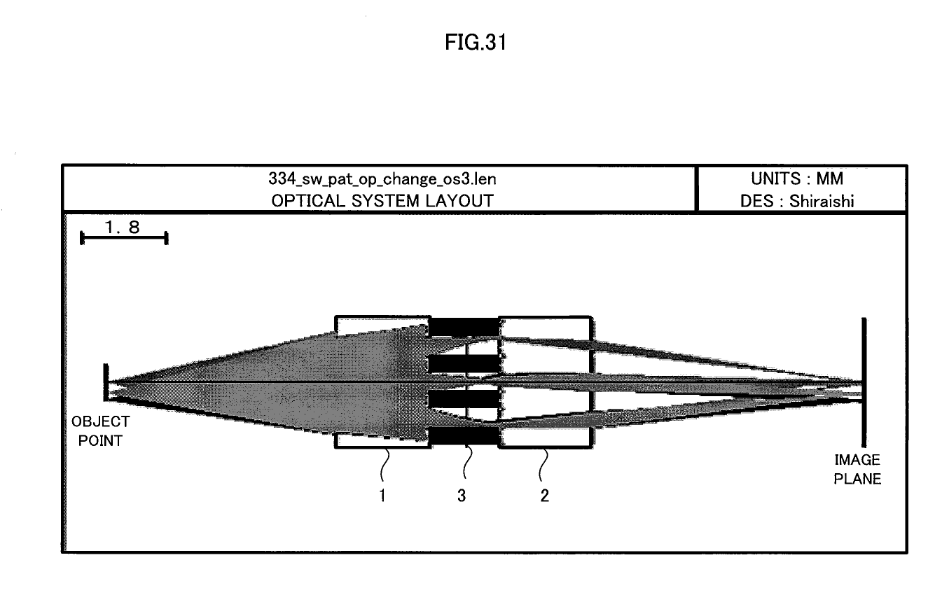

FIG. 31 is a diagram illustrating a configuration in which the lenses have the same lens data as that shown in FIG. 11 and the first and second apertures are implemented as a single aperture 3.

As described above, according to this embodiment, it is possible to suppress the occurrence of the stray light without significantly decreasing the light amount and without deepening the gap in the apertures and to implement a satisfactory MTF in the erect equal-magnification lens array constituted by two lenses and the apertures.

As described above in detail, according to the technique described in this specification, it is possible to provide an erect equal-magnification lens array which can achieve a large light amount with two lenses.

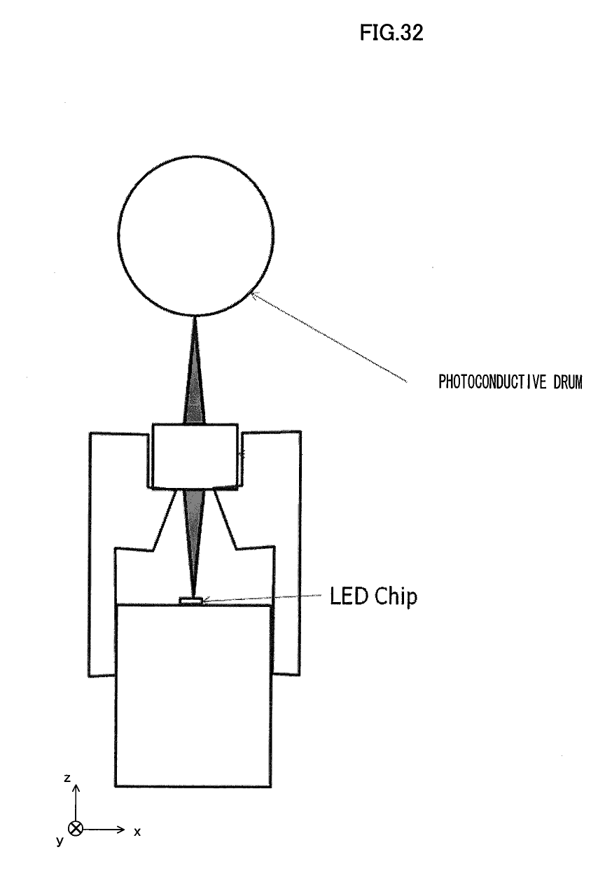

In addition, in the above embodiment, the description was made of a case where the erect equal-magnification lens array Q was applied to an optical system in a scanner. However, the present invention is not limited thereto, and it is needless to say that the erect equal-magnification lens array Q of the above embodiment can be employed for a writing optical system in an image forming apparatus as shown in FIG. 32, for example.

In such a case, the erect equal-magnification lens array Q guides the light from a light source to a photoconductive plane of a photoreceptor in the writing optical system for irradiating the photoreceptor with the light from an LED or an EL emitting unit. At this time, the “first direction” corresponds to the main-scanning direction.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An erect equal-magnification lens array comprising:
a plurality of first lenses aligned in a direction perpendicular to an optical axis and causing light incident from an object point to each incidence plane, which has at least a partially planar shape, to be collected by each outgoing plane which has a convex shape;
a plurality of second lenses aligned on a downstream side in a light beam proceeding direction on the optical axis of each of the plurality of first lenses in a direction perpendicular to the optical axis so as to correspond to each of the plurality of first lenses, having incidence planes each of which has a convex shape and is arranged in the vicinity of a position in the optical axis direction, at which the light is collected by each of the outgoing planes of the plurality of first lenses, and causing the light incident to each of the incidence planes to be collected again on an image plane using outgoing planes which have a convex shape; and
an aperture configured to shield light, from among the light collected by each of the outgoing planes of the plurality of first lenses, proceeding in a direction to be incident from each of the outgoing planes to the incidence planes of the second lenses other than the second lenses on the same optical axis.

2. The lens array according to claim 1,
wherein a curvature of the incidence plane of each second lens is greater than that of the outgoing plane of each first lens.

3. The lens array according to claim 1,
wherein a region in the incidence plane of each first lens, through which the light reaching the image plane passes, is formed in a planar shape.

4. The lens array according to claim 1,
wherein the object point and the incidence plane of each second lens are conjugate, and
wherein the incidence plane of each second lens and the image plane are conjugate.

5. The lens array according to claim 1,
wherein the first and second lenses are aligned such that the alignment number in a main-scanning direction is greater than that in a sub-scanning direction,
wherein the aperture includes a plurality of apertures configured to handle the light outgoing from the outgoing planes of the plurality of first lenses, and
wherein the centers of the respective apertures other than apertures from among the plurality of apertures, which are positioned in the center in the sub-scanning direction, are positioned further to the outside in the sub-scanning direction than the center of the corresponding first lens.

6. The lens array according to claim 1,
wherein the incidence plane of each second lens has a power which establishes a conjugate relation between the outgoing plane of each first lens and the outgoing plane of each second lens.

7. The lens array according to claim 1,
wherein a magnification from the object point to the incidence plane of each second lens and a magnification from the incidence plane of each second lens to the image plane are in a reciprocal relation.

8. The lens array according to claim 1,
wherein a magnification from the outgoing plane of each first lens to the outgoing plane of each second lens is less than 1.

9. The lens array according to claim 1,
wherein the incidence plane of each second lens is aspherical plane in which an absolute value of a curvature becomes smaller in the direction toward the outside from a lens center.

10. The lens array according to claim 1,
wherein the aperture includes a first aperture and a second aperture which is positioned on an downstream side of the first aperture in a light beam proceeding direction and is thicker than the first aperture.

11. The lens array according to claim 10,
wherein when ref1 represents a radius of an inscribed circle of a lens effective portion of the first lens, L1 represents a distance in the optical axis direction from a lens peripheral edge of the first lens to an edge of a hole of the first aperture which is closest to the first lens, L2 represents a distance in the optical axis direction from a plane of the first aperture on the side of the first lens to a plane of the second aperture on the side of the second lens, L3 represents a thickness of the second aperture in the optical axis direction, a3 represents a shortest distance from the optical axis of the first lens to an inner peripheral plane of a hole in the second aperture which is formed so as to correspond to another first lens adjacent to the first lens, and a4 represents a longest distance from the optical axis of the first lens to a inner peripheral plane of a hole in the second aperture which is formed so as to correspond to another first lens adjacent to the first lens, the following formula is satisfied:
L3>(a4−a3)/(a4+ref1)×(L1+L2)

12. The lens array according to claim 10,
wherein when ref1 represents a radius of an inscribed circle of a lens effective portion of the first lens, L1 represents a distance in the optical axis direction from a lens peripheral edge of the first lens to an edge of a hole of the first aperture which is closest to the first lens, L2 represents a distance in the optical axis direction from a plane of the first aperture on the side of the first lens to a plane of the second aperture on the side of the second lens, a1 represents a longest distance from the optical axis of the first lens to an inner peripheral plane of the hole in the first aperture which is formed so as to correspond to the first lens, and a2 represents a longest distance from the optical axis of the first lens to an inner peripheral plane of a hole in the second aperture which is formed so as to correspond to the first lens, the following formula is satisfied:
L1<(ref1−a1)/(a1+a2)×L2

13. The lens array according to claim 12,
wherein when ref1 represents a radius of an inscribed circle of a lens effective portion of the first lens, L1 represents a distance in the optical axis direction from a lens peripheral edge of the first lens to an edge of a hole of the first aperture which is closest to the first lens, L2 represents a distance in the optical axis direction from a plane of the first aperture on the side of the first lens to a plane of the second aperture on the side of the second lens, L3 represents a thickness of the second aperture in the optical axis direction, a3 represents a shortest distance from the optical axis of the first lens to an inner peripheral plane of a hole in the second aperture which is formed so as to correspond to another first lens adjacent to the first lens, and a4 represents a longest distance from the optical axis of the first lens to a inner peripheral plane of a hole in the second aperture which is formed so as to correspond to another first lens which is adjacent to the first lens, the following formula is satisfied:
L3>(a4−a3)/(a4+ref1)×(L1+L2)

14. The lens array according to claim 1,
wherein the first and second lenses are aligned in a hexagonal close-packed shape on a plane which is perpendicular to the optical axis and aligned such that the lens alignment number in a first direction where the distances between centers of adjacent lenses is the longest is more then the lens alignment number in a second direction which is perpendicular to the first direction.

15. The lens array according to claim 14,
wherein the erect equal-magnification lens array is configured to guide light from a light source to an original document reading target plane in a reading optical system for reading an image of an original document, and
wherein the first direction corresponds to a main-scanning direction.

16. The lens array according to claim 14,
wherein the erect equal-magnification lens array is configured to guide reflected light from an original document to a light-receiving device in a reading optical system for reading an image of an original document, and
wherein the first direction corresponds to a main-scanning direction.

17. The lens array according to claim 14,
wherein the erect equal-magnification lens array is configured to guide light from a light source to a photoconductive plane of a photoreceptor in a writing optical system for irradiating the photoreceptor with light, and
wherein the first direction corresponds to a main-scanning direction.
